(19) United States
(12) Patent Application Publication
(10) Pub. No.: US 2024/0375395 A1
(43) Pub. Date: Nov. 14, 2024

(54) METHOD FOR LAMINATING A BUILDING PANEL CORE WITH A SELF-ADHESIVE USE LAYER AND BUILDING PANEL CORE LAMINATED WITH A SELF-ADHESIVE USE LAYER

(71) Applicant: WEDI GMBH, Emsdetten (DE)

(72) Inventor: Stephan Wedi, Emsdetten (DE)

(73) Assignee: WEDI GMBH, Emsdetten (DE)

(21) Appl. No.: 18/690,493

(22) PCT Filed: Sep. 14, 2022
(86) PCT No.: PCT/EP2022/075500

§ 371 Date: Mar. 8, 2024

(30) Foreign Application Priority Data
Sep. 15, 2021 (DE) 10 2021 123 893.5

(51) Int. Cl. B32B 37/26; B32B 37/00; B32B 37/10; B32B 37/18; B32B 38/00; B32B 41/00

(52) U.S. Cl. CPC B32B 37/26; B32B 37/0053; B32B 37/10; B32B 37/18; B32B 38/0004; B32B 41/00; B32B 2037/268; B32B 2307/554; B32B 2419/00

(57) ABSTRACT

A method and system for laminating a building board core with a use or wear layer, and a resultant board, in which the board core is provided with a lamination material on its top side and/or bottom side. A cover sheet that is provided as the lamination material has a wear layer provided with an adhesive layer and a peel-off film on the adhesive layer. To automate the manufacturing process and comply with predefined working conditions, the peel-off film is pulled off the adhesive layer with a predefined peel-off force and the wear layer is fixed to the top side or the bottom side of the board core by a pressure roller. Faults can occur if changing boundary conditions cause a change in the pull-off force, in which case a deviation between the relevant actual value and the predefined target value can lead to a fault in the process.

### CROSS REFERENCE TO RELATED APPLICATIONS

This application is the US National Phase of, and claims priority on and the benefit of, International Application No. PCT/EP2022/075500 having an International Filing Date of 14 Sep. 2022, which claims priority on German Patent Application No. 10 2021 123 893.5 having a filing date of 15 Sep. 2021.

### BACKGROUND OF THE INVENTION

### Technical Field

The invention relates to a method for laminating a building board core with a wear layer, in which the building board core to be laminated is first cut to size and provided and then provided with a lamination material on its top side and/or underside. The lamination material thus forms a wear layer on the building board core.

### Prior Art

Lamination refers to the covering of a building board with a sheet material, for example a top layer sheet. In contrast, coating is the application of a liquid or paste-like material to a building board. Laminated building boards or building boards laminated with a top layer are used in particular in new buildings and in the renovation of interiors, for example in conjunction with drywall constructions. Such drywall constructions are used in hotels, hospitals, schools, office buildings and in residential construction, regardless of the construction method, especially for bathrooms and damp rooms. The building boards comprise a building board core, which usually consists of a plastic foam and can have a cementitious coating. The building boards can be flat, but they can also have a prefabricated contour. An example of a building board with a prefabricated contour is a shower floor panel with an integrated drain and a slope towards the drain.

JP H08 261 797 A discloses a lamination system for applying a lamination to a plate-shaped carrier, for example a metal roof panel. In order to laminate these special panels, the lamination system comprises an unwinding roller on which a lamination web is rolled up. The lamination web comprises a top layer, an adhesive layer and a peel-off film. In order to coat the metal plate with the top layer, the release film applied to the top layer is removed by machine and then rolled onto a roll-up roller. The top layer is glued onto the carrier during this process. The problem with this system is that the force with which the peel-off film is removed can depend on external boundary conditions. If these external boundary conditions change during the lamination process, faults can occur.

DE 29918 518 U1 discloses a hand roller for compacting and deaerating impregnated glass fiber mats. Although this hand roller can be used to press a lamination applied to a building board core onto the building board, the hand roller is not suitable for automatically applying lamination webs to building boards on an industrial scale.

JP 2004 338 408 A discloses a method and a device for laminating films. This system and this method also do not provide for any automated adaptation measures to changing boundary conditions.

U.S. Pat. No. 10,710,351 B2 describes a laminating system for applying a top layer, initially provided with a peel-off film, to a substrate. However, the process described there is intended for laminating optical display panels and is unsuitable for use on building boards as used in the construction sector. Moreover, the system disclosed in U.S. Pat. No. 10,710,351 B2 also involves the risk that changing external boundary conditions may disrupt the lamination process.

DE 10 2011 101 462 B4 discloses a method for manufacturing a building board with at least three layers. The building board comprises:
a layer of moisture-resistant plastic foam,
a water-resistant, adhesive, brittle hardened transition layer applied to the plastic foam layer,
and a fleece that is connected to the plastic foam layer via the transition layer.
   The manufacturing process comprises the following steps:
a) Applying an adhesive layer, which later forms the transition layer, to the plastic foam layer by applying an adhesive evenly during the pot life of the adhesive, the pot life being set so that the adhesive remains in a low-viscosity state for a sufficient processing time,
b) Pressing a glass fiber fleece onto the adhesive layer during the pot life, whereby a contact pressure on the fleece is set so that more than 50% to about 80% of the thickness of the fleece is saturated with adhesive,
c) Allow to cure or cure the adhesive layer.

A disadvantage of the known method is that the work process for producing one or more building boards cannot be interrupted without further ado. The adhesive, which may be a 2-component adhesive, for example, is applied in a liquid state and must then harden. It is also difficult or even impossible to coat the top and underside of a building board at the same time, as the liquid adhesive cannot be easily applied to the underside of a panel.

### BRIEF SUMMARY OF THE INVENTION

An object of the invention is to eliminate the disadvantages described and to propose a manufacturing process that can be used both on a building board top side and on a building board bottom side and can be started and stopped as required with minimized set-up, pre-run and post-run times.

Furthermore, it is an object of the invention to propose a laminating system suitable for the application of the process as well as a building board that can be produced at low cost.

This problem is solved by a method with a method for laminating a building board core with at least one wear layer, comprising the steps of cutting to size and providing at least the building board core, which has a top side and a bottom side, providing a lamination material for forming the wear layer, whereby a top layer web is provided as the lamination material, the top layer web comprising a wear layer provided with an adhesive layer and a peel-off film arranged on the adhesive layer, the top layer web is provided on an unwinding roller for laminating the top side or the bottom side of the building board core on a lamination system, the building board core is fed to the lamination system, the wear layer and the peel-off film are separated from one another by coupling a free end of the peel-off film to a peel-off film roll-up roller and bringing the wear layer into contact with its adhesive layer on the top side or on the bottom side of the supplied building board core, the peel-off film is peeled off the adhesive layer with a predefined peel-off force, the wear layer is fixed to the top side or the bottom side of the building board core by means of a pressure roller, characterized in that a sensor measures an actual value of the peel-off force acting on the adhesive bond between the wear layer and the peel-off film, a controller compares the actual value of the pull-off force with the predefined setpoint value, and when a control deviation is detected, a controlled variable, preferably a torque or a distance between the pressure roller and the wear layer is changed so that the actual value is adjusted to the setpoint value.

The problem according to the invention is also solved by a lamination system for adhering a self-adhesive wear layer to a building board core, comprising a conveyor system for transporting the building board cores, at least one unwinding roller for receiving a top layer web, the top layer web comprising a wear layer provided with an adhesive layer and a peel-off film arranged on the adhesive layer, at least one roll-up roller for receiving the peel-off film separated from the adhesive layer, at least one pressure roller for pressing the wear layer onto the building board core, characterized in that the unwinding roller and/or the roll-up roller and/or the pressure roller and/or the conveyor system has an adjustable drive by means of which a peel-off force acting on the peel-off film can be varied.

The problem according to the invention is also solved by a building board produced according to teachings herein or with a lamination system according to the teachings herein, comprising a building board core, an adhesive layer and a wear layer.

### DEFINITIONS

A building board core is a panel-shaped element that can consist of different types of material or material combinations depending on the requirements or intended use of the end product. Examples of building board cores that can be provided with a self-adhesive wear layer include
Standard building boards with a plastic foam core material plus a cementitious lamination with fabric insert on one or both sides,
Uncoated rigid foam panels, which are made from an extruded or expanded polystyrene rigid foam, for example, panels with different coatings on both sides,
Sheets made from a raw material other than plastic foam, for example
   Mineral wool panels,
   Boards made of cellular material (paper or wood base materials),
   Panels made of metal foam,
   Panels made from a honeycomb material.

A top layer web is understood to be a multilayer semi-finished product that comprises at least three layers, namely:
at least one wear layer which, depending on the application, may be a vapor-tight film and/or nonwoven layer and/or a reinforcing fabric or another material or combination of materials,
an adhesive layer that is preferably created on the basis of a PSA (Pressure Sensitive Adhesive), as a PSA adhesive is permanently tacky or adhesive on the surface and has a long service life before it sets or hardens and thus loses its suitability as an adhesive for a peel-off film,
a release liner.
   The way a PSA adhesive works is that it does not set or harden. The adhesive only achieves approx. 80% of its adhesive strength immediately after laminating the sealing membrane, but this increases to 100% after approx. 2 days. This means that there is only an adhesive bond between the sealing membrane and the substrate.

Top layer webs are available on the market in various designs.

When using the method according to the invention, a top layer web is provided as the lamination material instead of an adhesive applied in the liquid state, the top layer web comprising a wear layer provided with an adhesive layer and a release film arranged on the adhesive layer. In further process steps:
the top layer web is provided on an unwinding roller for laminating the top side or the underside of the building board core on a lamination system,
the building board core is fed into the lamination system,
the top layer is separated from the peel-off film by coupling a free end of the peel-off film to a peel-off film roll-up roller and bringing the top layer into contact with its adhesive layer and the top side or the underside of the supplied building board core,
the peel-off film is removed from the adhesive layer with a predefined peel-off force,
the wear layer is fixed to the top or underside of the building board core by means of a pressure roller.

To put it simply, a peel-off film, which is first stuck to the adhesive layer of a wear layer, is peeled off and the wear layer is then stuck to the panel core. It is essential to the invention that the film is not peeled off with an arbitrary force, but with a predefined peel force.

On the one hand, the peel force must be high enough to prevent creases from forming on the panel during application. On the other hand, the peel force must not be so great that the film is pulled too far forward during application. This can also cause wrinkles. The actual size of the predefined peel force depends on the material properties of the self-adhesive top layer and its components as well as on the design of the laminating system, for example the arrangement of the deflection and pressure rollers. Tests can be carried out to determine the force required to ensure that the top layer is applied without creases. The values determined in this way for different top layer webs and/or different lamination systems can be stored in list form or in a data memory and are available there when required, in particular when reconfiguring a lamination system to a new top layer material.

In the manufacturing process according to the invention
a sensor measures an actual value of the peel-off force acting on the adhesive bond between the wear layer and the peel-off film,
the actual value of the pull-off force is compared with a predefined target value, namely the predefined pull-off force, by means of a controller,
and when a control deviation is detected, a control variable, preferably at least one of the torques applied to the rollers, is changed so that the actual value is adjusted to the setpoint value.

The above measures form a simple control loop. In principle, however, other types of control loops or control loops equipped with other sensors are also possible. It is essential that the measured parameters allow conclusions to be drawn about suitable measures that can be used to change the system settings so that the predefined extraction force is kept constant.

As an alternative to determining the peel-off force using a force sensor, an optical sensor, for example a light barrier or a camera, or a mechanical sensor, for example a feeler, can also be provided. The optical or mechanical sensor can be used to detect the position or alignment of the wear layer after the peel-off film has been removed. If the optical or mechanical sensor detects that the wear layer is being pulled forward by the peel-off film, the peel-off force is too high and must therefore be reduced. If, on the other hand, the position of the wear layer shifts backwards, the peel force is too low and must be increased.

The use of this method has many advantages:
The usable layers and usable layer surfaces exhibit a high degree of variance:
   This makes it possible to use different colors and patterns for the wear layer, which can be easily adapted to the subsequent paint coat,
   The wear layer can be provided with a pattern print, for example a check pattern. Such a pattern facilitates subsequent cutting work on the finished, laminated building board,
   The wear layer can be provided with a product name imprint that identifies the subsequent end product. For example, an imprint on the panel core to be glued, which identifies the preliminary product, can be pasted over with the wear layer so that only the product name of the end product printed on the wear layer is legible.
The fact that no liquid adhesive is used, which has to harden after application, reduces the system changeover times when switching production from one wear layer material to another or from one building board core to another building board core. Short changeover times enable small batch sizes to be produced cost-effectively.
The lamination system can be started up and shut down at short notice so that, for example, production breaks at the end of a shift or in the event of faults result in no or very little loss of efficiency.
Mortar curing times during the production process are eliminated.
The grid-like structure of a panel with a reinforcing mesh embedded in mortar can be concealed by applying an additional wear layer. The surface is (largely) smooth and can therefore simply be painted over.
Necessary reworking of the installed panel is eliminated or at least reduced. At least the “rough filling” work step is no longer necessary.
A high vapor impermeability (SD value) of the finished product is also possible with less vapor-tight or even non-vapor-tight base board materials, as the top layer web can contain a vapor-tight film. This means that completely different board base materials can be included in the selection, where the focus is not on vapor tightness but on other properties (e.g. thermal insulation, sound insulation, fire protection, fatigue strength/stiffness of the board, etc.).

The method according to the invention enables the automated gluing of a wide variety of panels with a wide variety of wear layers. The panels covered with the wear layer do not require any further reworking after production and are therefore ready for sale.

Preferably, the peel-off film is pulled off the top layer web by means of a peel-off film roll-up roller and rolled onto the peel-off film roll-up roller. This makes it easy to set the predefined force that is optimal for releasing the peel-off film, for example by means of a drive coupled to the peel-off film roll-up roller. Furthermore, the peel-off film wound on the roll-up roller can be stored in a space-saving manner and subsequently disposed of easily.

In a preferred embodiment of the process, a wear layer is bonded to both the top side and the underside of the building board core in a single operation, with the process steps preferably being carried out synchronously with one another. It is advantageous that, in contrast to the application of a liquid coating, it is also possible to bond building board cores to the underside of the board. This means that two work steps are not required for lamination on both sides (as is the case when applying a liquid coating). Instead, a self-adhesive top layer can be applied to both sides of the building board core in a single work step using a laminating system in which two rolls with top layer webs are integrated.

Preferably, to realize the predefined pull-off force
the drive torque of the unwinding roller and/or
the drive torque of the peel-off film take-up roller and/or
the drive torque of the pressure roller and/or
a gap between the pressure roller and the wear layer
   is set to a predefined setpoint value for the respective parameter.

In a simple embodiment of the process, manual adjustability can be provided. The different setting options allow an optimized combination of default values to be preselected depending on the materials used and the desired results. The combination and the default values can, for example, be preselected in such a way that the bonding process is particularly fast and efficient. However, they can also be preselected in such a way that quality criteria, such as low wrinkling, are prioritized.

In order to facilitate the setting of the predefined pull-off force and to reduce the risk of incorrect settings due to operator errors, the setting can be made on the basis of default values for system parameters, for example for drive torques, stored in a data memory of the laminating system. Preferably, the setting is automated by means of a system control, which on the one hand has access to the default values stored in the data memory and on the other hand can control the system parameters. For example, it is possible for the operating personnel to use a suitable selection menu to preselect only one version of a top layer web and a building board core stored in the data memory and for the machine control system to automatically make the system settings required for this combination.

Preferably, the predefined pull-off force is not only set once, but is monitored and kept constant by means of a control loop. The background to this is that a peel-off force initially set to the predefined value can change over time due to external circumstances. For example, the amount of material wound onto the top layer unwinding roller or the peel-off film roll-up roller has an influence on the force required to unwind one roll and wind the other. Without a corresponding readjustment, the peel-off force exerted on the peel-off film changes while the drive torque on the rollers remains the same. By monitoring and readjusting the predefined peel-off force by means of a control circuit, any deviations from a peel-off force currently exerted on the peel-off film can be compensated for in relation to the predefined peel-off force.

The method according to the invention can comprise a process step in which the top side and/or underside of the building board core to be laminated is cleaned of dust and dirt by means of a cleaning system before gluing. This cleaning can include a brush (roller) and/or one or more (pulsating) air streams/air nozzles. Cleaning reduces the risk of the aforementioned dust and dirt particles settling between the building board core and the wear layer and becoming visible under the glued-on wear layer after gluing.

Preferably, the method according to the invention is used in a continuous process for producing a plurality of laminated building boards. Thus, at least two, preferably a plurality of building board cores can be laminated directly one after the other on their top side and/or on their lower side with a self-adhesive wear layer. A gap sensor can be used to check whether the at least two building board cores are in contact with each other. If this is not the case and there is a gap between the building board cores that exceeds a predefined maximum dimension, an emergency stop control can be provided, which stops the system and enables the cause of the fault to be searched for and rectified.

Preferably, the self-adhesive wear layer on the top side and/or the underside of the building board core is pressed onto the building board core with a pressure roller, which is flexible.

The flexibility of the pressure roller also allows it to adapt to uneven surfaces. For example, building board cores that are already provided with a reinforcing mesh embedded in mortar usually have elevations of 0.5 mm to 2 mm in the area of the reinforcing threads and corresponding indentations in the mesh between the threads. The flexible pressure roller adapts to this contour when in use and ensures that the bonding of the adhesive is not only carried out on the highest points of the reinforcement threads, but also in the mesh recesses in between.

If the building board core to be laminated is a semi-finished product for the production of a shower base with an integrated drain and a slope towards the drain, the flexibility of the pressure roller can be designed in such a way that the pressure is applied both in the thicker edge areas of the shower base and in the thinner drain area, which is deeper than the edge area. The pressure exerted by the pressure roller on the wear layer thus extends over the entire width of the tile surface.

Preferably, a self-adhesive wear layer is provided with a width that does not exceed the width of the building board core to be laminated. The wear layer therefore has a tolerance dimension whose maximum value is smaller than the minimum value of the tolerance of the building board width. When gluing on a wear layer that has an identical or almost identical width to the building board core, even slight running inaccuracies will result in the wear layer protruding beyond the building board core on one side or the other when glued on. Such protrusions should be avoided, as they can build up between adjacent building boards during the subsequent installation of finished building boards on walls and floors and may require reworking, such as additional sanding.

To avoid this, the application of the wear layer to the building board core is preferably controlled by means of a control loop. A control loop provided for aligning the wear layer can, for example, be designed in such a way that:
a side edge of the self-adhesive top layer or the wear layer or the release liner is detected by means of a first sensor,
a lateral stop edge of the building board core is detected by means of a second sensor,
the actual position of the self-adhesive top layer or the wear layer or the peel-off film detected by the first sensor is compared with the stop edge detected by the second sensor,
the alignment of the wear layer is corrected by means of a controller so that the actual value determined by the first sensor is adjusted to the target value. The correction can be made, for example, by guiding the top layer web over a deflection roller mounted in a support frame during unwinding and readjusting the alignment of the support frame—and thus the deflection roller—if necessary.

The process for laminating a building board core can also include a control loop by means of which the pressure exerted by the pressure roller on the self-adhesive wear layer is kept constant at a predefined pressure value or within a predefined pressure value range.

Such a control loop thus forms a pressure control system that keeps the pressure with which the pressure roller presses the lamination web onto the building board constant. For this purpose, a suitable sensor is used during the lamination process to measure the pressure exerted by the pressure roller on a lamination web that has previously, preferably immediately beforehand, been glued to the substrate in predefined time units or continuously. The instantaneous actual value determined in this way is compared with a predetermined target value by means of a control system provided for this purpose and, if a deviation is detected, readjusted.

This type of control is particularly advantageous for changing tile geometries. For example, shower base tiles often have a slope. In the case of a shower base tile installed in a building structure, this slope guides the water hitting the shower base tile in the direction of a water drain. If such a shower base panel, which is thicker on one side than on the other, passes through the lamination system, the pressure roller presses the lamination membrane against the substrate material with varying degrees of force in a non-regulated system: where the panel is thick, the contact pressure during panel passage is high and where the panel is thinner, it is lower. The pressure control ensures that the contact pressure is increased during the sheet pass in proportion to the pressure drop caused by the sheet becoming thinner in the pass direction.

Such a pressure drop can be compensated for not only with evenly thinner or thicker substrates, but also with irregular geometries, such as one or more depressions in a building board, for example a shower floor panel with a central drain and a slope aligned in the direction of the central drain.

The problem according to the invention is also solved by a lamination system for bonding a self-adhesive wear layer to a building board, which comprises at least the following assemblies:
a conveyor system, for example a roller conveyor or a belt conveyor, for transporting the building board cores,
at least one unwinding roller for receiving a top layer web, the top layer web comprising a wear layer provided with an adhesive layer and a peel-off film arranged on the adhesive layer,
at least one roll-up roller for holding the peel-off film separated from the adhesive layer,
at least one pressure roller for pressing the wear layers onto the building board core,
   wherein the unwinding roller and/or the roll-up roller and/or the pressure roller and/or the conveyor system has an adjustable drive, by means of which a peel-off force acting on the peel-off film can be varied.

The fact that the peel force can be set to a predefined value for the respective material combination ensures that the self-adhesive wear layer is bonded evenly and wrinkle-free to the core of the building board to be laminated. Electric motors, by means of which the torque and/or the speed of the rollers can be regulated, are particularly suitable for driving the rollers.

Preferably, the lamination system comprises at least one flexible pressing agent that adapts to the surface contour of a building board core with an uneven surface contour during lamination. The flexible pressing means can, for example, be a sheathing of the pressing roller with a flexible rubber or a plastic foam.

Regardless of how the flexibility of the pressure roller is realized, the pressure roller with the flexible pressure means presses the wear layer onto the surface of the building board core without wrinkles. Due to the radial contour of the pressure roller, a V-shaped widening free space is formed directly in front of the contact line between the pressure roller and the board surface, into which the air in front of the contact line can escape. This prevents the formation of air pockets and bubbles below the wear layer.

The flexible pressure roller can also be used independently of the described system or on systems other than the described system. For example, it may be provided that the flexible pressure roller is integrated into a device which is only intended to press a lamination material onto a carrier material. In this case, the aforementioned device, which can also be referred to as a pressing device, comprises at least one flexible roller and a counter bearing, whereby the distance between the flexible roller and the counter bearing is preferably adjustable.

Furthermore, the lamination system can comprise means for forming a pressure control for the flexible pressure roller. In particular, these means can include one or more sensors for measuring the pressure on the pressure roller, adjustment means for varying the position of the pressure roller, for example electric, pneumatic or hydraulic cylinders, and a control unit.

In order to apply the lamination material to the carrier material, at least one of the two materials is preferably provided with an adhesive layer. After placing the lamination material on the carrier material and setting a suitable distance between the flexible roller and the counter bearing, the assembly covered with the lamination material is guided through the pressure device. The flexible pressure roller adapts to the contour of the carrier material and presses the lamination material against the carrier material with a largely uniform pressure force. Any air pockets or air bubbles present between the carrier material and the lamination are pressed away in the opposite direction to the conveying direction by continuously advancing the assembly in relation to the pressure device.

In a special embodiment, at least two pressure rollers can be provided, whereby the pressure rollers preferably have flexible pressure means and press the wear layer against the core of the building board in different areas. The multiple pressure rollers can be arranged one behind the other or next to each other, as seen in the direction in which the building boards pass through the lamination system, and can include pressure sensors. The pressure sensors measure the contact pressure of the respective pressure roller on the panel surface and can be part of a control loop by means of which the distance between the pressure roller and the panel surface is set so that the top layer is pressed onto the panel surface with a predefined contact pressure.

An embodiment with several pressure rollers is particularly advantageous if the building board to be laminated has a profile with height differences when viewed in the transverse direction. In such a case, the pressure rollers can be set to different height levels in order to optimize the pressing of the wear layer against the surface of the building board. For example, a square shower base panel with a central drain in the middle has a slope towards the drain and is therefore thinner in the middle than in the outer areas. Since larger height differences can only be insufficiently compensated for by the flexible pressing means when using a single pressing roller, two or more rollers can be provided in such a case, the distance of which to the tile surface is adapted to the surface level present in the respective area. As a result, the use of several pressure rollers makes it possible to evenly press a wear layer onto a building board surface, even in the case of building boards with irregular height profiles and/or depressions.

As an alternative to a rigid counter bearing, a second flexible pressure roller can be provided. This makes it possible to coat both sides of a carrier material and to press the lamination evenly against both sides of the carrier material as it passes through the pressure device.

As an alternative or in addition to a pressure roller with a flexible casing, a pressure roller with a support shaft and at least two individual segments that can be attached to it can also be provided. The individual segments are preferably variably displaceable in the axial direction of the support shaft and can each have a flexible casing.

In addition to a flexible casing, the individual segments can also be flexible in themselves. For example, the individual segments can be lamellar wheels which, when unloaded, have the same radius over the entire circumference. In the case of a lamellar wheel, an inner and an outer wheel rim are connected to each other by lamellae arranged between them. If pressure is exerted on the lamellar wheel, the disks deform. During operation, i.e., when the wear layer is pressed against the core of the building board, the radius of a lamellar wheel is reduced at the load point.

With a large number of lamellar wheels arranged on the support shaft, each wheel deforms individually depending on the contact pressure applied. For example, if a shower floor panel with a slope runs through the lamination system, the lamellar wheels are pressed in more strongly where the panel is thicker than where the panel is thinner. Overall, however, pressure is exerted on the bonding surface across the entire width of the panel.

Two pressure rollers arranged one behind the other can be provided on the system to ensure that both outer sides of the panel are aligned with the outer side of a lamellar wheel, even with panels of different widths. The position of the lamellar wheels can be fixed with locking devices. This makes it possible to align the lamellar wheels of the first roller with one outer edge of the panel and the lamellar wheels of the second roller with the other outer edge of the panel.

The problem of the invention is further solved by a laminated building board which comprises a building board core, an adhesive layer and a wear layer and has been produced by the method described or on the plant described.

Further measures that improve the invention are shown in more detail below with the description of preferred embodiments of the invention with reference to the figures.

### BRIEF DESCRIPTION OF THE DRAWINGS

The figures show:

FIG. 1 shows a schematic side view of a production line for the automated manufacture of laminated building boards;

FIG. 2 shows a schematic top view of the production line according to FIG. 1;

FIG. 3 shows a top layer web;

FIG. 4 shows an example of a building board core laminated with a self-adhesive wear layer;

FIG. 5 shows a lamination system;

FIG. 6 shows a section A1 from FIG. 4;

FIG. 7 shows a section A2 from FIG. 4;

FIG. 8 shows a perspective view of a single segment designed as a lamellar wheel;

FIG. 9 shows a side view of the lamellar wheel as shown in FIG. 7;

FIG. 10 shows a schematized run-through of a building board in relation to the function of two pressure rollers; and

FIG. 11 shows a schematic representation of the passage of building boards through a lamination system with three pressure rollers.

### DETAILED DESCRIPTION OF PREFERRED EMBODIMENTS

Identical or similar elements may be provided with identical or similar reference signs in the figures. Furthermore, the figures in the drawings, their description and the claims contain numerous features in combination. It is clear to a person skilled in the art that these features can also be considered individually or that they can be combined to form further combinations not described in detail here. The invention also expressly extends to such embodiments which are not given by combinations of features from explicit references in the claims, which means that the disclosed features of the invention can be combined with one another as desired, insofar as this makes technical sense. The embodiments shown in the figures are therefore only descriptive and are not intended to limit the invention in any way.

The terms “upper”, “top”, “bottom”, “left”, or “right” used in the following refer to the arrangement of a lamination system or its components in the operating mode of the lamination system shown in the drawing.

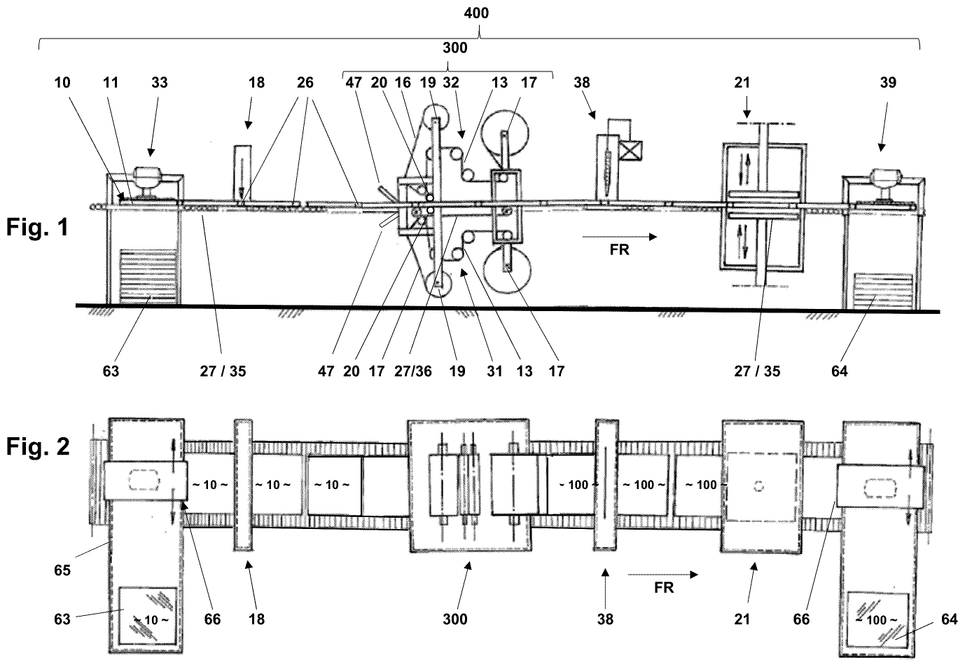

FIGS. 1 and 2 show a production line 400 for the automated production of building board 100 laminated with a self-adhesive wear layer 15. The production line 400 has a lower top layer web feed 31 and an upper top layer web feed 32. A top layer web 13, which is a lamination material 200, is fed to a lamination system 300 via each of the top layer web feeders 31 and 32. An example of a top layer web 13 is shown in FIG. 2.

The production line 400 also includes:
A feeding station 33 for feeding building board cores 10. In the embodiment example shown, individual building board cores 10 are removed from a provided panel stack 63 by means of a loading robot and placed on a conveyor system 27 by means of a trolley 66 coupled to rails 65.
A conveyor system 27, which is formed from roller conveyors 35 and/or belt conveyors 36 and is used to transport the building board cores 10 or the laminated building boards 100. In principle, other and/or additional components can also be used to form the conveyor system 27, for example belt conveyors.
A marking station 18 for applying markings 26 to the side surfaces of the building board cores 10.
At least one cross-cutting system 38.
A pressing station 21 for firmly bonding the wear layers 15 to the building board cores 10.
An pick-up station 39, at which the finished laminated building boards 100 are removed from the production line 400 by means of a loading robot in the same way as at the feeding station 33 and stacked on a panel stack 64.

In the illustrated embodiment example, the cutting system 38 is designed as a cross-cutting system. The cutting system 38 and the pressing station 21 are fixed to the production line 400. Alternatively, an overhung mounting of the cutting system 38 and/or pressing station 21 can also be used. A flying mounting is understood to be an attachment that moves analogously to the conveying movement of the building boards 100 with the building boards 100 to be cut or pressed.

The roller conveyor 35 is a component of the conveyor system 27. The conveyor system 27 transports the building board cores 10, or the laminated building boards 100, from the feeding station 33 to the pick-up station 39 via a number of processing stations explained below in a conveying direction FR. In the embodiment example shown, the conveyor system 27 also has a belt conveyor 36 in the area of the laminating system 300 and a further roller conveyor 35 downstream of the laminating system 300.

The building board cores 10 are initially spaced apart from one another on the roller conveyor 35. At the marking station 18, a marking 26 is applied to one side end of each building board core. In the embodiment example shown, the marking is a color marking applied with a printer. The marking serves to make the butt joint between two building board cores clearly visible. This is particularly important because the building board cores, which are initially spaced apart from each other, are pushed together as they progress so that the wear layer 15 can be glued to the building board cores 10, which are positioned one behind the other, in a web-like manner.

The marked end of a building board core 10 abuts the unmarked end of the following building board core 10 during series production. A transition marked in this way can be easily recognized by an operator with the naked eye and also by means of a colour sensor and used as a contact point for a stop angle (manual operation) or a cutting system 38 (automated operation). Regardless of whether the top layer web is cut manually or automatically, the cut for separating two building boards can be carried out precisely using the joint edge marking.

In order to prevent the marking on the ends of the panels from being visible on the finished building boards 100, the marking can also be made using a fluorescent material. The fluorescent material can be made visible under black light, i.e., under ultraviolet radiation. For this purpose, a UV lamp 45 is installed in the cutting area of the lamination system 300 or the production line 400, which is directed at the side areas of the building boards passing through the system (see FIG. 6). Under UV light, the operator or the color sensor integrated in the cutting system 38 can then easily see the joint edge of two laminated building boards 100. Since the building board cores 10 themselves are already prefabricated in predefined sizes, the cut to be made only cuts through the useful wear layer 15. Depending on whether the building board core 10 has been laminated on one or both sides with a wear layer 15, the cut is of course also made on one or both sides of the building board core. The marking thus makes it possible for the wear layers 15 applied to the building board cores 10 to be cut at the exact point where the butt joint between two building board cores 10 is located.

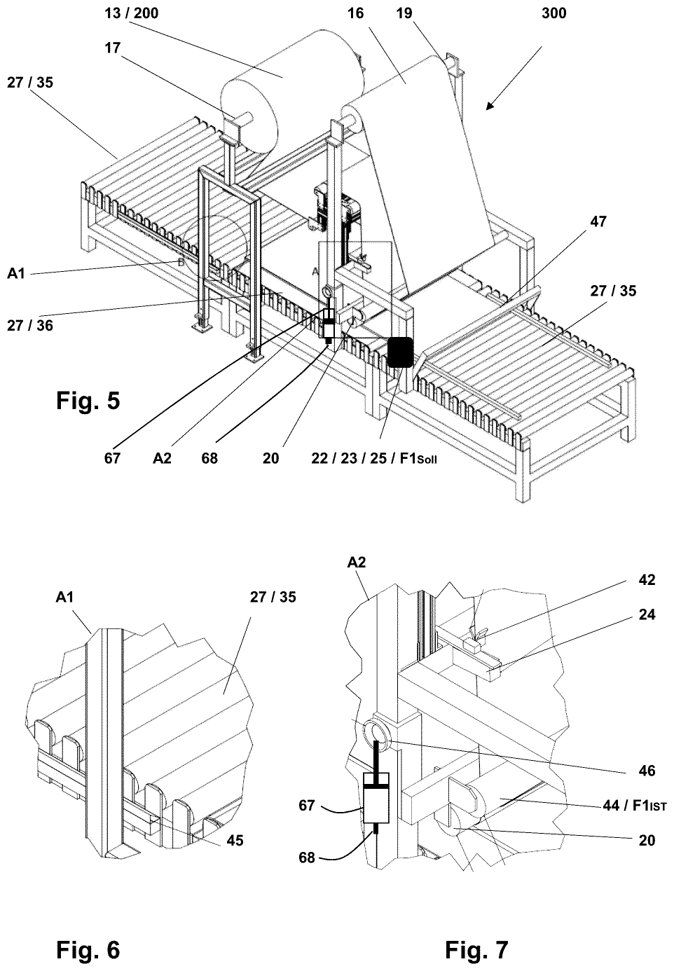

After the building board cores 10 have received a laterally applied marking 26, they are pushed together and transported on to the lamination system 300. The operation of the lamination system 300 is explained in detail below in connection with the explanation in FIG. 5.

Using the cutting system 38, a panel strand formed by gluing the wear layer 15 onto the building board cores 10 is cut exactly at the contact point of two building board cores 10. The prefabricated building board cores 10 are not damaged in the process. In a computer-controlled cutting system 38, the panel sizes and interfaces can be programmed. In an automated cutting system 38, the transition can be detected by a sensor and a knife integrated into the cutting system 38 can be positioned precisely.

In manual cutting mode, for example, a steel angle on the panel can be positioned exactly at a joint edge of two building board cores 10 so that the manual cut hits the joint.

In the illustrated embodiment example, a pressing station 21 is provided downstream of the cutting system 38. By means of the pressing station, pressure is again applied to the wear layer 15, which is already adhered bubble-free to the upper and/or lower side of the building board core 10, in order to intensify the adhesive bond between the building board core 10 and the wear layer 15. The pressing station 21 can comprise a stamp that has a negative shape on its pressure side that is compatible with the contour of the positive shape of the building board core 10. The wear layer 15 can be pressed at a stationary station or continuously with the conveying movement of the building board cores 10 at a moving station.

Preferably, the pressing station comprises a vacuum press. The vacuum press encloses the laminated building board 100 with a membrane and extracts the air in the space between the membrane and the workpiece using a vacuum pump. The greater the difference between the ambient pressure and the pressure below the membrane, the greater the effect of atmospheric pressure on the workpiece. With an oil-lubricated vacuum pump, vacuum tables achieve a vacuum of up to 98%. Once this value is reached, the air column presses on the workpiece with approximately 10 tons per square meter. The even pressure distribution on the surface ensures that the wear layer 15 is pressed evenly onto the core of the building board 10. The vacuum thus ensures that a membrane encloses the laminated building board 100 and that the parts to be joined are pressed together at high pressure.

After pressing, the finished laminated building board 100 is conveyed to a pick-up station 39, where it is removed from the production line 400 manually or by means of a robot.

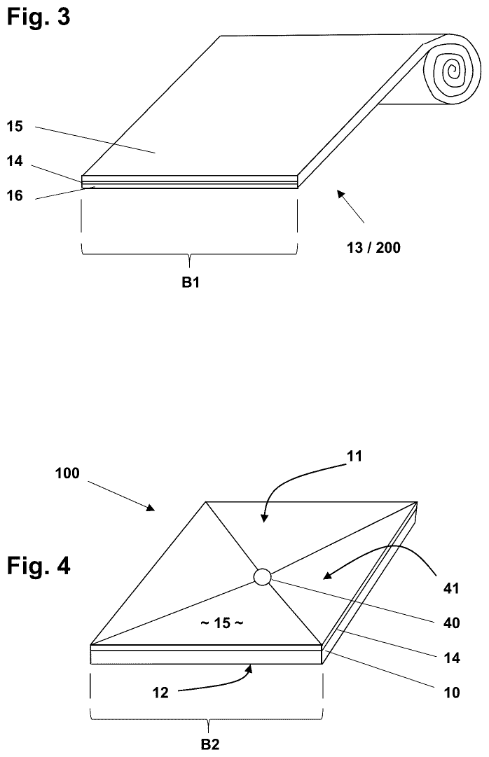

FIG. 3 shows an example of a top layer web 13 comprising a wear layer 15, an adhesive layer 14 and a peel-off film 16 attached to and removable from the adhesive layer 14. As already explained above, the wear layer 15 can consist of a wide variety of materials or combinations of materials.

FIG. 4 shows a laminated building board 100, which is designed as a shower base panel in the example shown. The shower base panel has a drain 40 arranged centrally in the middle and a gradient 41 pointing towards the drain 40. The shower base panel shown comprises a building board core 10 with a top side 11 and a bottom side 12. The self-adhesive wear layer 15 with its adhesive layer 14 is glued to the top side 11. Since the shower floor panel is intended for installation in a damp room and is preferably covered with a tile covering after installation, a wear layer 15 is provided in which a film and an overlying non-woven layer are integrated. The film, which is at least waterproof, preferably vapor-tight, prevents water from penetrating into the building board core 10. The non-woven layer forms an adhesive base for the tiles or tile adhesive to be applied.

FIG. 5 shows a lamination system 300, which can be integrated into a production line 400 as shown in FIG. 1. The lamination system 300 has a conveyor system 27 in the form of a roller conveyor 35 on its inlet side and on its outlet side. In the central area of the lamination system 300, a conveyor system 27 in the form of a belt conveyor 36 is arranged between the aforementioned roller conveyors 35. The conveyor systems 27 first transport the building board cores 10 to a cleaning system 47, which cleans the surface to be laminated of dust and dirt. This cleaning can include a brush roller or one or more air nozzles that generate pulsating air flows. After passing through the cleaning system 47, the building board cores 10 are passed through a gluing station in which the wear layer 15 of a top layer web 13 is glued to the top side 11 of the building board cores 10.

The lamination material 200 is formed by the wear layer 15 and is integrated into the top layer web 13. The top layer web 13 is initially located on an unwinding roller 17 and is guided towards the building board core 10 via several deflections. The deflections are used to align and level the top layer web 13.

Opposite the unwinding roller 17 is a roll-up roller 19, onto which the peel-off film 16 removed from the wear layer 15 is wound. Both the unwinding roller 17 and the roll-up roller 19 have an adjustable rotary drive (not shown).

A combination of a pressure measuring roller 44 and a pressure roller 20 is arranged above the belt conveyor 36. The paths of the wear layer 15 and the peel-off film 16 separate at the pressure measuring roller 44. The peel-off film 16 is guided to the roll-up roller 19 via a further deflection. On the other hand, the wear layer 15 with its now exposed adhesive layer 14 is pressed onto the top side 11 of a building board core 10 located underneath the pressure roller 20 and fixed there. The distance between the pressure roller 20 and the building board core 10 can be adjusted by means of a height adjustment device 46. The pressure roller 20 can also have a rotary drive.

The force with which the peel-off film 16 is pulled off the adhesive layer 14 depends on the force or torque with which the unwinding roller 17, the roll-up roller 19 and the pressure roller 20 are driven. Furthermore, the peeling force depends on the distance between the pressure roller and the panel surface. All the parameters mentioned can be adjusted so that an optimum combination can be determined for the respective application. A suitable combination of setting parameters is characterized by the fact that the force required to peel off the peel-off film is reduced as a result:
is large enough to prevent wrinkles from forming when the wear layer 15 is glued on, and
on the other hand, is not so large that the wear layer 15 is pulled too far forward during gluing.
   Such a peel force is referred to as F1SOLL. The peel force F1SOLL can be different for different top layer webs 13, but should be kept constant during production for the top layer web 13 currently being processed in the production process.

However, the peel force is not only dependent on the drives and the distance mentioned, but also on factors that change during the production process. For example, during the production process, the top layer web 13 rolled up on the unwinding roller 17 is reduced and, at the same time, the overall thickness of the unwinding roller is reduced. At the same time, the roll-up roller 19 becomes increasingly thicker as the peel-off film 16 is rewound. Both factors influence the peel-off force and thus form disturbance variables in the production process. In order to compensate for the effects of such disturbance variables on the set peel-off force F1SOLL, the drives and/or the distance from the pressure roller to the plate surface are readjusted if necessary.

In the embodiment example shown, a sensor for measuring the web tension is integrated into the pressure roller 20 and/or the pressure measuring roller 44. Readjustment is required if this sensor detects an actual value F1IST that deviates from the predefined target value F1SOLL beyond a predefined tolerance range. As an alternative or in addition to measuring the actual value F1IST by means of a sensor integrated in the pressure roller 20 or pressure measuring roller 44, an actual value F1IST can also be determined in a different way, for example by using a distance sensor to determine the sagging of the top layer web 13 or the peel-off film 16 at a suitable point.

A sensor 24 (see FIG. 7) provided in the illustrated embodiment example is used to set the sealing sheet precisely to a laminating position intended with regard to the building board by means of a control frame and to readjust the predefined exact setting position if necessary.

The control and regulation of the drives and also of the distance from the pressure roller to the plate surface can be realized individually or in combination by means of a system control 22. The system control 22 preferably comprises a data memory in which the predefined set values F1SOLL for different materials and predefined setting values for the controllable drives and distances are stored. Furthermore, the system control 22 comprises one or more controllers 25 with which control loops can be realized.

In the embodiment shown in FIG. 5, the lamination system 300 has only one unwinding roller 17 and one roll-up roller 19. This system is thus designed for laminating one side of a building board core 10. Analogous to the version of a production line 400 shown in FIG. 1 with a lamination system for applying lamination material 200 on both sides, the lamination system 300 shown in FIG. 5 could also be converted in such a way that simultaneous laminating on both sides is possible. For this purpose, a further top layer web 13 can be fed to the bottom side 12 of the building board cores 10 via an additional unwinding roller 17 and the peel-off film 16 of the lower top layer web 13 can be wound up by means of a further roll-up roller 19. The control of the parameters relevant with regard to the additional lower top layer web 13 would also have to be integrated into the system control 22.

It is of course possible to cover the top side 11 and the bottom side 12 with different wear layers 15.

In the illustrated embodiment example, the pressure roller 20 comprises a support shaft 29 and a plurality of flexible individual segments 30, which in the illustrated embodiment example are lamellar wheels 48. The lamellar wheels 48 ensure that the wear layer 15 is pressed onto the building board core 10 over its entire width B1. This prevents air pockets or bubbles from forming between the wear layer 15 and the building board core 10.

In the illustrated embodiment example, the pressure roller 20 further comprises a control for the pressure force exerted by the pressure roller 20 on the wear layer 15—and thus indirectly also on the building board core 10. In order to measure and vary the currently exerted pressure force, the height adjustment device 46 comprises two cylinders 67, one of which acts on each side of the pressure roller 20 (see FIG. 7). If both cylinders 67 are retracted or extended evenly, the pressure roller 20 is raised or lowered evenly in relation to the wear layer 15. The cylinders 67 comprise integrated pressure sensors 68 for measuring the pressure exerted on the wear layer 15. The instantaneous pressure force determined in this way is transmitted to a control system, which can be integrated into the system control 22. In the control system, the instantaneous pressure force is compared with a predefined target value. If a deviation is detected, a corresponding control command is used to extend or retract one or both cylinders 67 so that the instantaneous pressure force is adjusted to the predefined target value.

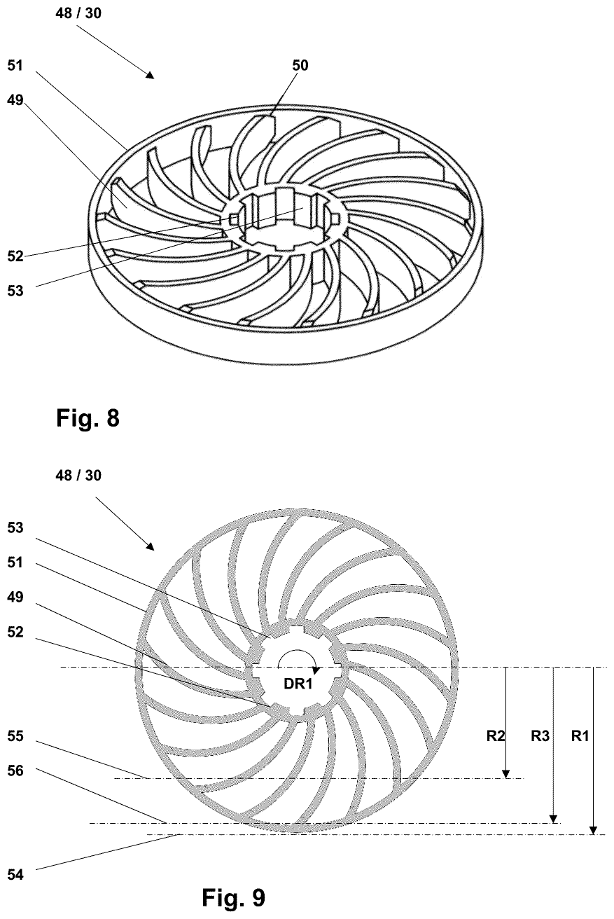

FIGS. 8 and 9 show a lamellar wheel 48 in detail. The lamellar wheel 48 has an inner wheel rim 52 with a profile 53. The profile 53 can be attached to a corresponding profile of the support shaft 29. The support shaft 29 is driven by a drive not shown. The drive is adjustable. A torque applied to the support shaft 29 can thus be transmitted to the lamellar wheel 48 via the profile 53.

The lamellar wheel 48 also has an outer wheel rim 51, which is connected to the inner wheel rim 52 via curved slats 49. Preferably, the lamellar wheel 48 rotates in the direction of rotation DR1 during operation. This ensures that the curved slats 49 can change their contour with little resistance.

During operation, a running plane is formed at the point of contact between the lamellar wheel 48 and the core 10 (see FIG. 9). In the unloaded state, a running plane 54 with a radius R1 is in contact with the contact point of the lamellar wheel 48 and the building board core 10. In this state, the lamellar wheel 48 therefore exerts no pressing force on a wear layer 15 located between the lamellar wheel 48 and the building board core 10.

In order to press on the wear layer 15 with a minimum contact pressure, the lamellar wheel 48 must therefore be pretensioned. The pretension is achieved by reducing the distance between the pressure roller 20 and the building board core 10 by means of the height adjustment device 46. In order to ensure trouble-free running and sufficient pressure at the same time, an instantaneous actual running plane that is present in the production process moves between a minimum running plane 55 with a radius R2 and a maximum running plane 56 with a radius R3 during the entire board run. The difference between the radii R3 and R2 thus defines the working range of the lamellar wheels 48.

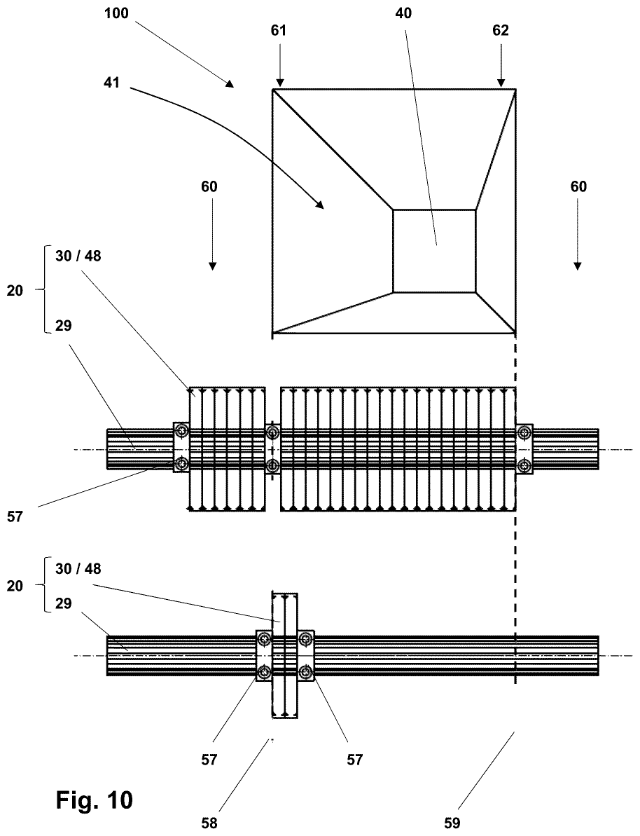

In principle, a lamellar wheel 48 can be designed so wide that it covers the entire width B2 of the building board 100. With such a very wide lamellar wheel, it is possible to adapt to panel contours that only have a uniform inclination or a uniform slope in the longitudinal direction of the panel conveying movement. In order to apply sufficient pressure to all areas of the panel, even in the case of building boards 100 with inclines on all sides, for example in the case of a laminated building board 100 in the form of a shower base with an incline on all sides shown in FIG. 4 or 10, it is also possible to mount not just one, but a plurality of individual segments 30, or lamellar wheels 48, on a support shaft 29. Each lamellar wheel 48 can then adapt individually to the contour of the laminated building board 100 in the area of this lamellar wheel 48.

The outer wheel rim 51 is itself flexible to a certain extent and/or has a flexible casing. This flexibility makes it possible to compensate for minor unevenness in the width range of an individual lamellar wheel 48. For example, the height differences of a reinforcement grid integrated into the working position described above can be compensated for in this way.

Furthermore, the flexibility in the area of the outer wheel rim 51 makes it possible to equalize the contact pressure at the transition point between two lamellar wheels. In particular, if the slats 49 have chamfers 50 towards the outer wheel rim 51, the edge areas of a ring gear can deform slightly. The main compressive force is therefore not applied by the ring gear at the edges, but in the central area. This reduces the risk of the outer edge of an lamellar wheel 48 becoming visible on the finished laminated building board 100 in the form of a line impression.

Furthermore, it can be advantageous if the outer edge of a lamellar wheel 48 is aligned with the outer edge of a building board 100. However, since the building board 100 can have very different widths and the lamellar wheels 48 are preferably all of the same width and can therefore be used universally, the lamination system 300 can have a second support shaft 29 for attaching additional lamellar wheels 48.

Such a situation is shown in FIG. 10 in a schematically illustrated passage of a building board 100 through a lamination system 300 with two pressure rollers 20. Both pressure rollers 20 each comprise a profiled support shaft 29 and individual segments 30 arranged thereon. The individual segments 30 are fixed to the support shaft 29 with locking devices 57 and cannot move axially during operation.

On the support shaft 29 facing the building board 100, the individual segment 30 located on a right outer edge 62 is adjusted by means of a locking device 57 so that the outer edge of this individual segment 30 lies on the same escape line 59 as the right outer edge 62 of the building board 100. However, the left outer edge 61 of the building board 100 does not lie on a common escape line with an outer edge of an individual segment 30 rolling over this area. In order to confront the left outer edge 61 and the right outer edge 62 of the building board 100 with approximately the same pressing conditions, the left outer edge 61 has not been rolled over with the central area of an individual segment 30 in the embodiment example shown. Instead, the individual segments 30 are fixed on the first pressure roller in such a way that the left outer edge 61 is not rolled over by any of the individual segments 30 attached to this first pressure roller 20.

In the illustrated embodiment example, two individual segments 30 mounted on an additional pressure roller 20 are responsible for pressing a wear layer 15 onto the left outer edge 61 of the building board 100. The left individual segment 30 is fixed to the support shaft 29 in such a way that its outer edge lies on the same escape line 58 as the left outer edge of the building board 100.

The adjustment of the individual segments is variable overall. The individual segments can thus be positioned and fixed on the support shaft 29 as required by means of the locking devices 57.

In an embodiment with two or more pressure rollers 20, the height adjustment devices 46 can also be variable and independent of each other. This makes it possible to press any areas that are critical with regard to the adhesion of a wear layer 15 onto the building board 100 additionally or with other adjustment parameters.

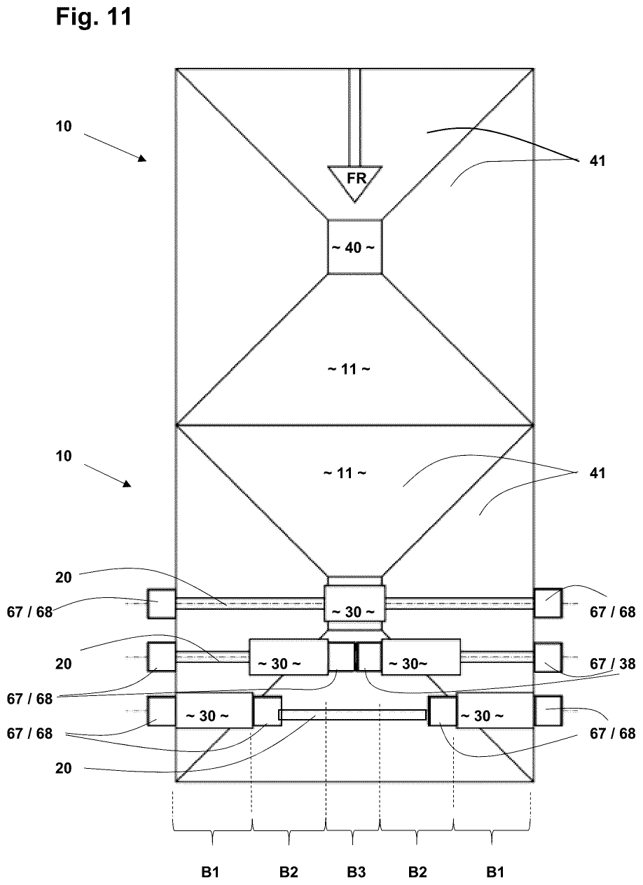

FIG. 11 schematically shows the passage of two building board cores 10 through a lamination system 300 equipped with three pressure rollers 20. The lamination system 300 itself is not shown, but only its pressure rollers 20. The first pressure roller 20 in the conveying direction FR only has an individual segment 30 in a central area B3. The individual segment 30 can comprise one or more lamellar wheels 48 (see FIG. 8). The first pressure roller 20 is mounted on both sides in the lamination system 300 and comprises a cylinder 67 with a sensor, in this case a pressure sensor 68, on its left and right outer sides. The building board cores 10 are provided as starting products for shower base elements and each have an opening for a drain 40 in their center. A slope 41 running towards the drain 40 is provided on all sides to ensure that the water flows into the drain 40 when installed. The building board core 10—and also the shower base element made from it—is therefore relatively thick on the outer sides and relatively thin in the area of the drain 40.

Because the individual segment 30 of the first pressure roller 20 is only arranged in the middle area B3, it can follow the thickness contour of the building board core 10 as it passes through the lamination system. When passing under the first pressure roller 20, the distance between the pressure roller 20 and the building board surface is selected so that the pressure roller exerts a predefined contact pressure on the surface of a lamination material to be applied to the building board core 10 (not shown in FIG. 11). As the building board core 10 continues to pass through the laminating system 300 in the direction FR, the distance between the pressure roller 20 and the surface of the building board core 10 increases due to the slope 41. This reduces the contact pressure exerted by the individual segment 30 on the surface of the building board core. The reduced contact pressure is detected by the sensors 68 interacting with the first pressure roller 20 and transmitted to the system control 22 (not shown in FIG. 11) in the form of an actual contact pressure value. In the system control 22, the actual contact pressure value is compared with the predefined contact pressure. If a deviation is detected that exceeds a likewise predefined tolerance range, the height setting of the pressure roller 20 is readjusted. To put it simply, as the contact pressure decreases, the distance between the pressure roller 20 and the building board core 10 is reduced by means of the cylinders 67 in order to press the pressure roller 20 more strongly against the top side 11 again. Since the individual segment 30 arranged on the first pressure roller 20 only contacts the middle area B3, the pressing of the laminating material in this area B3 is not impaired by the thicker structure of the building board core 10 in the areas B1 and B2.

Analogous to the first pressure roller 20, the individual segments 30 arranged on the second pressure roller 20 also only act on certain areas of the building board core 10, namely the areas B2. These second pressure rollers 20 are also equipped with sensors 68 and cylinders 67, so that the contact pressure on the surface of the building board core 10 can also be regulated in the areas B2 and can be kept constant during the passage of the building board core 10 through the lamination system 300.

In the embodiment example shown in FIG. 11, a third pressure roller 20 is also provided, which acts on outer areas B1 of the building board core 10. Analogous to the first and second pressure roller 20, the distance between the third pressure roller 20 and the top side 11 of the building board core is also controlled in the third pressure roller 20 in such a way that the pressure acting on the top side 11 is kept constant at the predetermined value or within a tolerance range provided for this value.

### LIST OF REFERENCE SYMBOLS

10 building board core
11 top side (from 10)
12 bottom side (from 10)
13 top layer web
14 adhesive layer (from 13)
15 wear layer (from 13)
16 peel-off film (from 13)
17 unwinding roller
18 marking station
19 roll-up roller
20 pressure roller
21 pressing station
22 system control
23 data memory
24 sensor
25 controller
26 marking
27 conveyor system
29 support shaft (from 20)
30 individual segment (to 29)
31 lower top layer web feed
32 upper top layer web feed
33 feeding station
35 roller conveyor
36 belt conveyor
38 cutting system
39 pick-up station
40 drain
41 slope
42 guide rail
44 pressure measuring roller
45 UV-lamp
46 height adjustment device
47 cleaning system
48 lamellar wheel
49 slat
50 chamfer
51 outer wheel rim (of 48)
52 inner wheel rim (from 48)
53 profile (in 52)
54 running plane (unloaded)
55 running plane (minimum)
56 running plane (maximum)
57 locking device
58 escape line
59 escape line
60 conveying direction
61 left outer edge (of 100 in FIG. 10)
62 right outer edge (of 100 in FIG. 10)
63 panel stack (building board core 10)
64 panel stack (laminated building boards 100)
65 rail
66 trolley
67 cylinder
68 sensor (for 67)
100 laminated building board
200 lamination material
300 lamination system
400 Production line
A1 section (from FIG. 5)
A2 section (from FIG. 5)
B1 width (from 15)
B2 width (from 10)
F1IST actual value (of the pull-off force)
F1SOLL setpoint (of the pull-off force)
B1 area
B2 area
B3 area
FR conveying direction
R1 radius (from 54)
R2 radius (from 55)
R3 radius (from 56)

1. A method for laminating a building board core (10) with at least one wear layer (15), comprising the steps of:
cutting to size and providing at least the building board core (10), which has a top side (11) and a bottom side (12),
providing a lamination material (200) for forming the wear layer (15), whereby
a top layer web (13) is provided as the lamination material (200), the top layer web (13) comprising a wear layer (15) provided with an adhesive layer (14) and a peel-off film (16) arranged on the adhesive layer (14),
the top layer web (13) is provided on an unwinding roller (17) for laminating the top side (11) or the bottom side (12) of the building board core (10) on a lamination system (300),
the building board core (10) is fed to the lamination system (300),
the wear layer (15) and the peel-off film (16) are separated from one another by coupling a free end of the peel-off film (16) to a peel-off film roll-up roller (19) and bringing the wear layer (15) into contact with its adhesive layer (14) on the top side (11) or on the bottom side (12) of the supplied building board core (10),
the peel-off film (16) is peeled off the adhesive layer (14) with a predefined peel-off force (F1SOLL), and
the wear layer (15) is fixed to the top side (11) or the bottom side (12) of the building board core (10) by means of a pressure roller (20),
wherein
a sensor measures an actual value (F1IST) of the peel-off force acting on the adhesive bond between the wear layer (15) and the peel-off film (16),
a controller (25) compares the actual value (F1IST) of the pull-off force with the predefined setpoint value (F1SOLL), and
when a control deviation is detected, a controlled variable, preferably a torque (M) or a distance between the pressure roller (20) and the wear layer (15) is changed so that the actual value (F1IST) is adjusted to the setpoint value (F1SOLL).

2. The method for laminating a building board core (10) according to claim 1, wherein the wear layer (15) is applied on the top side (11) and on the bottom side (12) of the building board core (10), and the steps are preferably being carried out synchronously with one another.

3. The method for laminating a building board core (10) according to claim 1, wherein for adapting the actual value (F1IST) to the desired value of the predefined peel-off force (F1SOLL)
the drive torque (M1) of the unwinding roller (17), and/or
the drive torque (M2) of the peel-off film roll-up roller (19), and/or
the drive torque (M3) of the pressure roller (20) is adjusted.

4. The method for laminating a building board core (10) according to claim 1, wherein the predefined peel-off force (F1SOLL) is set on the basis of preset values stored in a data memory (23) of the lamination system (300), the setting preferably being carried out automatically by means of a system control (22).

5. The method for laminating a building board core (10) according to claim 1, wherein the peel-off force (F1SOLL) is kept constant by means of a control circuit.

6. The method for laminating a building board core (10) according to claim 1, wherein the top side (11) and/or bottom side (12) of the building board core (10) to be laminated is cleaned by means of a cleaning system (47) before gluing.

7. The method for laminating a building board core (10) according to claim 1, wherein at least two building board cores (10) are laminated directly one after the other on their top side (11) and/or on their bottom side (12) with the wear layer (15) and a gap sensor is used to check whether the at least two building board cores (10) are in contact with one another, wherein the wear layer (15) is a self-adhesive wear layer.

8. The method for laminating a building board core (10) according to claim 1, wherein the wear layer (15) is a self-adhesive wear layer that is pressed onto the top side (11) and/or the bottom side (12) of the building board core (10) by means of a pressure roller (20) which is flexible.

9. The method for laminating a building board core (10) according to claim 1, wherein:
the wear layer (15) is a self-adhesive wear layer that is provided with a width (B1) which does not exceed a width (B2) of the building board core (10) to be laminated, and
before gluing, the alignment of the self-adhesive wear layer with respect to the building board core (10) is controlled by means of a control circuit in such a way that the wear layer (15) does not protrude beyond the building board core (10) in the glued state.

10. The method for laminating a building board core (10) according to claim 1, wherein a control loop is provided, by means of which the pressure force exerted by the pressure roller (20) on the wear layer (15) is kept constant at a predefined pressure value or a predefined pressure value range.

11. A lamination system (300) for adhering a self-adhesive wear layer (15) to a building board core (10), the system comprising:
a conveyor system (27) for transporting the building board cores (10),
at least one unwinding roller (17) for receiving a top layer web (13), the top layer web (13) comprising a wear layer (15) provided with an adhesive layer (14) and a peel-off film (16) arranged on the adhesive layer (15),
at least one roll-up roller (19) for receiving the peel-off film (16) separated from the adhesive layer (14), and
at least one pressure roller (20) for pressing the wear layer (15) onto the building board core (10),
wherein the unwinding roller (17) and/or the roll-up roller (19) and/or the pressure roller (20) and/or the conveyor system (27) has an adjustable drive by means of which a peel-off force (F1IST) acting on the peel-off film (16) can be varied.

12. The lamination system (300) according to claim 11, wherein the pressure roller (20) comprises a flexible pressure means which adapts to a building board core (10) with an uneven surface contour during the lamination of this surface contour.

13. The lamination system (300) according to claim 11, wherein at least two pressure rollers (20) are provided, the pressure rollers preferably having flexible pressure means and pressing the wear layer (15) against the building board core (10) in different areas (B1, B2, B3).

14. The lamination system (300) according to claim 11, wherein the pressure roller (20) comprises a support shaft (29) and at least two individual segments (30) which can be variably mounted on the support shaft (29) in the axial direction of the support shaft (29).

15. The lamination system (300) according to claim 14, wherein one or more lamellar wheels (48) are provided as individual segments (30), which have a radius (R1) in the unloaded state and a reduced radius (R2) at the load point when the wear layer (15) is pressed against the building board core (10).

16. A laminated building board (100) comprising a building board core (10), an adhesive layer (14) and a wear layer (15), wherein the laminated building board (100) is produced by a method for laminating a building board core (10) with at least one wear layer (15), comprising the steps of:
cutting to size and providing at least the building board core (10), which has a top side (11) and a bottom side (12),
providing a lamination material (200) for forming the wear layer (15),
whereby
a top layer web (13) is provided as the lamination material (200), the top layer web (13) comprising a wear layer (15) provided with an adhesive layer (14) and a peel-off film (16) arranged on the adhesive layer (14),
the top layer web (13) is provided on an unwinding roller (17) for laminating the top side (11) or the bottom side (12) of the building board core (10) on a lamination system (300),
the building board core (10) is fed to the lamination system (300),
the wear layer (15) and the peel-off film (16) are separated from one another by coupling a free end of the peel-off film (16) to a peel-off film roll-up roller (19) and bringing the wear layer (15) into contact with its adhesive layer (14) on the top side (11) or on the bottom side (12) of the supplied building board core (10),
the peel-off film (16) is peeled off the adhesive layer (14) with a predefined peel-off force (F1SOLL), and
the wear layer (15) is fixed to the top side (11) or the bottom side (12) of the building board core (10) by means of a pressure roller (20),
wherein
a sensor measures an actual value (F1IST) of the peel-off force acting on the adhesive bond between the wear layer (15) and the peel-off film (16),
a controller (25) compares the actual value (F1IST) of the pull-off force with the predefined setpoint value (F1SOLL), and
when a control deviation is detected, a controlled variable, preferably a torque (M) or a distance between the pressure roller (20) and the wear layer (15) is changed so that the actual value (F1IST) is adjusted to the setpoint value (F1SOLL).
